(19) United States
(12) Patent Application Publication
(10) Pub. No.: US 2007/0198434 A1
(43) Pub. Date: Aug. 23, 2007

(54) Method and apparatus for generating rights object by means of delegation of authority

(75) Inventors: Young-suk Jang, Uijeongbu-si (KR); Seung-chul Chae, Suwon-si (KR); Jae-won Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/650,500

(22) Filed: Jan. 8, 2007

(30) Foreign Application Priority Data
Feb. 6, 2006 (KR) 10-2006-0011182

(51) Int. Cl. H04L 9/00

(52) U.S. Cl. 705/67

(57) ABSTRACT

Provided are a method and apparatus for generating a rights object by means of the delegation of authority. The method includes performing authentication with a rights issuer; receiving a first rights object from the rights issuer; receiving authorization signature information from the rights issuer; converting the first rights object into a second rights object by using the authorization signature information; and transmitting the second rights object to an unauthorized device.

### CROSS-REFERENCE TO RELATED APPLICATION

This application claims priority from Korean Patent Application No. 10-2006-0011182 filed on Feb. 6, 2006 in the Korean Intellectual Property Office, the disclosure of which is incorporated herein by reference in its entirety.

### BACKGROUND OF THE INVENTION

1. Field of the Invention

Methods and apparatuses consistent with the present invention relate to the use of content by digital rights management (DRM), and more particularly, to methods and apparatuses for generating a rights object by means of the delegation of authority.

2. Description of the Related Art

FIG. 1 shows a process of generating and distributing a rights object for corresponding content that is provided from an Open Mobile Alliance (OMA) DRM architecture according to the related art. As shown in FIG. 1, devices D1 (10), D2 (20), D3 (30), and D4 (40) in a domain are registered in a corresponding service provider as members of the domain through a registration procedure, and then share content and a rights object with other devices. The representative device D1 (10) can transmit the content and the rights object acquired from a rights issuer 50 to the other devices D2 (20), D3 (30), and D4 (40) to share the content and the rights object with the devices. Then, the other devices can reliably use information of the received content and rights object by using information from the service provider.

In a general DRM system, in order to prevent the illegal use of content, a content provider or a rights issuer encrypts content and transmits the encrypted content. In addition, in order to protect the use of content, a rights object including a content usage rule is issued, thereby protecting rights of the original author. In order for the protection of a copyright, a DRM device is designed to forcibly protect the usage rule included in the rights object.

In an OMA MRM architecture version 2.0, rights information on corresponding content is shared by using a domain, and the sharing process is performed as shown in FIG. 1.

First, it is assumed that four devices are provided in one domain. In a domain technique based on a server, a content server includes encrypted content, an encryption key for using the encrypted content, a route certificate for generating a rights object including a usage rule, and a service provider certificate. The route certificate is a certificate of a certificate issuer for check using an authentication system, and the service provider certificate is a certificate of the certificate issuer for certifying a public key of a service provider.

In the flowchart shown in FIG. 1, the devices D1 (10), D2 (20), and D3 (30) are registered in a rights issuer 50 and take part in the domain (step 1). The device D1 (10) acquires content and rights from the rights issuer 50 (step 2), and transmits the acquired content and rights to the devices D2 (20) and D3 (30) (step 3). Meanwhile, even when the device D1 (10) transmits the content and the rights to the device D4 (40) in step 4, the device D4 (40) cannot receive the content and the rights since it has not registered in the rights issuer 50 yet. Therefore, step 5 of registering in the rights issuer and joining the domain needs to be performed.

A process of generating a rights object of the encrypted content will be described in detail below. The service provider performs a content packaging process to generate the encrypted content and the rights object. The rights object includes a content encryption key (CEK) obtained by encrypting content and a usage rule. When the rights object is generated, important information, such as CEK, is encrypted into a key of the device D1 (10) requiring the content. Therefore, a key for decrypting the content can be obtained by using only the key of the device D1 (10), and thus the corresponding content can be used by only the device D1 (10) requiring the content.

The rights object is signed with a private key, and the device D1 (10) checks the signature of the rights issuer 50 using its own route certificate. If the signature of the rights issuer is incorrect, the device D1 (10) cannot use the rights object.

A process of using the generated content and rights object is as follows. In order to use the received content, a device having received the content and the rights object checks the received signature of the rights issuer 50 of the rights object, decrypts a rights encryption key (REK) of the rights object, and decrypts the content encryption key (CEK) using the REK. Then, the device decrypts the content using the obtained CEK and uses the content according to the usage rule included in the rights object.

As described above, in the server-based redistribution model, in order for redistribution, a device should always be reissued with a rights object from the rights issuer 50.

Therefore, when content is redistributed by using a local domain manager, the following problems arise. First, when the local domain manager changes a key included in its own rights object to a domain key to share the domain key with other devices in the domain, the signature of a service provider is not valid any longer. As a result, the service provider loses rights to control the content changed by the local domain manager, which may cause unauthorized content to be distributed.

Second, the service provider cannot know whether a certain domain formed by the local domain manager exists. In addition, the service provider cannot know what devices use content, which constraints the use of content are subjected to, and which domain content is used.

Third, in order to use the received content and rights object, the devices (including a rendering device) in the domain need to previously know the public key of the local domain manager and should verify the validity of the certificate of the local domain manager. That is, when the local domain manager is hacked, illegal redistribution of information may occur.

The following problem arises when content is shared in the OMA DRM environment. In order to use content, each device should be issued with a rights object from the rights issuer, and the rights object is signed with the key of the rights issuer. Therefore, each device can authenticate the rights object received from the rights issuer with the key of the rights issuer. That is, in order to use content, all devices should have the key of the rights issuer. Therefore, a method and apparatus for solving the above-mentioned problem are needed.

### SUMMARY OF THE INVENTION

Aspects of the present invention are made in view of the above-mentioned problems, and it is an aspect of the invention to provide a technique for using a rights object without an unnecessary authentication process.

It is another aspect of the invention to provide a technique for transmitting a rights object among devices within the range in which the rights object can be legally used.

The invention is not limited to the above-mentioned aspects, and other aspects of the invention not described herein will become clear to those skilled in the art upon review of the following description.

According to an aspect of the invention, there is provided a method of transmitting authorization signature information, the method including authenticating a device; transmitting to the device a first rights object required to use a predetermined content; and transmitting to the device the authorization signature information required to convert the first rights object to a second rights object.

According to another aspect of the invention, there is provided a method of generating a rights object by means of the delegation of authority, the method including performing authentication with a rights issuer; receiving a first rights object from the rights issuer; receiving authorization signature information from the rights issuer; converting the first rights object into a second rights object by using the authorization signature information; and transmitting the second rights object to an unauthorized device.

According to still another aspect of the invention, there is provided an apparatus for generating a rights object by means of the delegation of authority, the apparatus including a security managing unit performing authentication with a rights issuer and managing a first rights object from the rights issuer; an authorization signature information storage unit receiving authorization signature information from the rights issuer and storing the received authorization signature information; a second-rights-object generating unit converting the first rights object into a second rights object by using the authorization signature information; and a transmitter/receiver unit transmitting the second rights object to an unauthorized device.

### BRIEF DESCRIPTION OF THE DRAWINGS

The above and other features of the present invention will become more apparent by describing in detail exemplary embodiments thereof with reference to the attached drawings, in which:

FIG. 1 is a diagram illustrating a process of generating a rights object for corresponding content and distributing the generated rights object that is provided from an OMA DRM architecture according to the related art;

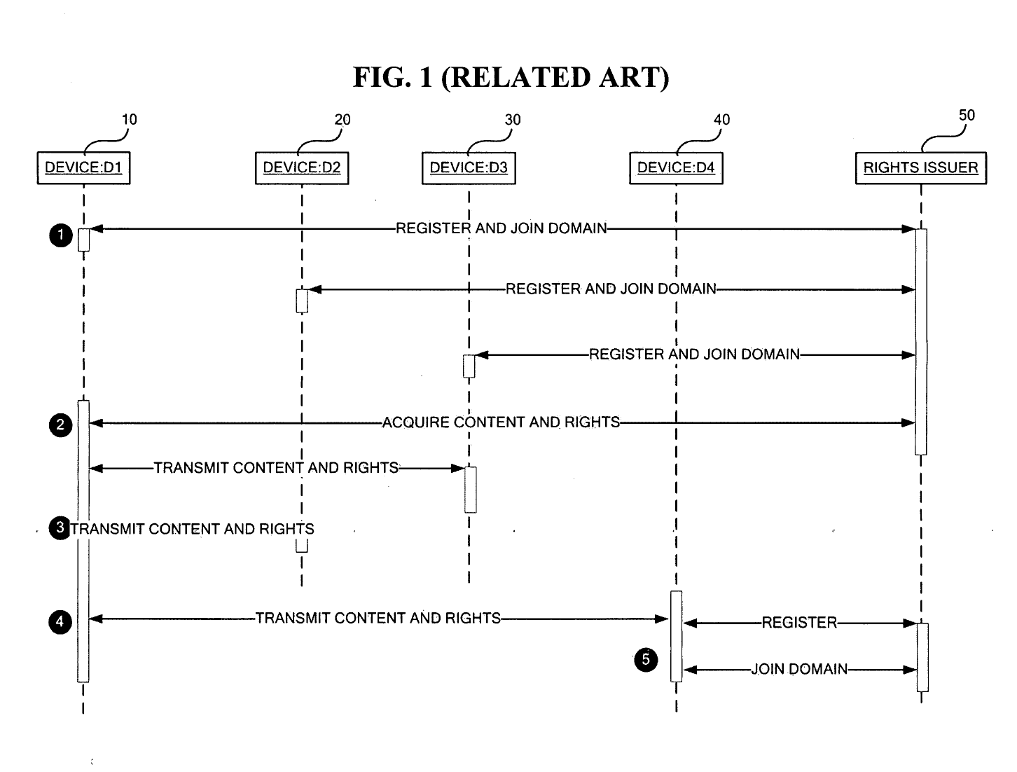

FIG. 2 is a flowchart illustrating a process of generating a second rights object according to an exemplary embodiment of the invention;

FIG. 3 is a diagram illustrating a process of generating a rights object according to an exemplary embodiment of the invention;

FIG. 4 is a diagram illustrating a change in the configuration of a rights object according to an exemplary embodiment of the invention;

FIG. 5 is a diagram illustrating components of a device having authorization signature information according to an exemplary embodiment of the invention;

FIG. 6 is a flowchart illustrating a process of registering a device and of generating a second rights object according to an exemplary embodiment of the invention; and

FIG. 7 is a diagram illustrating an exemplary embodiment of the invention.

### DETAILED DESCRIPTION OF EXEMPLARY EMBODIMENTS OF THE INVENTION

Features consistent with the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. In the specification, the same components have the same reference numerals.

Aspects of the present invention are described hereinafter with reference to flowcharts and block diagrams for illustrating a method and apparatus for generating a rights object by means of the delegation of authority according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, generate means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

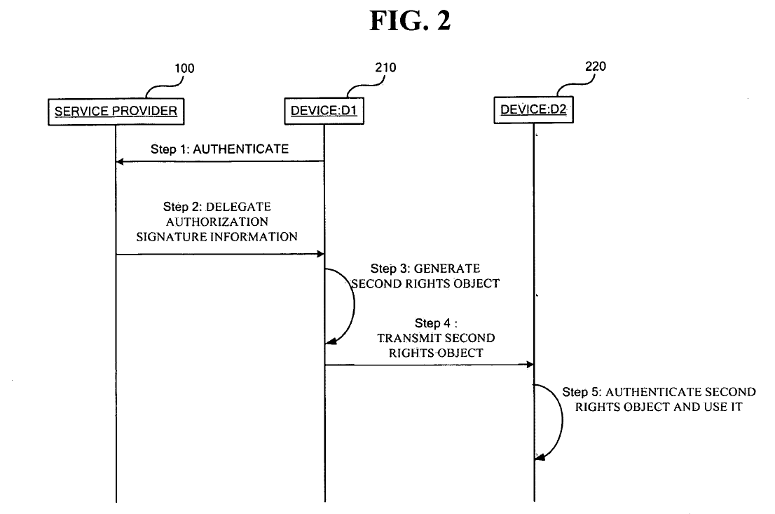

FIG. 2 is a flowchart illustrating a process of generating a second rights object according to an exemplary embodiment of the invention. A service provider or a rights issuer 100 authenticates a device D1 (210) in step 1. The service provider 100 transmits predetermined authorization signature information to the device D1 (210) in step 2. The authorization signature information is limited signature information for allowing a rights object to be generated.

Then, the device D1 (210) generates a second rights object for redistribution using the received authorization signature information in step 3, and then transmits the second rights object to a device D2 (220) as shown in step 4. In order to obtain a rights object of corresponding content, the device D2 (220) acquires from the device D1 (210) the second rights object generated by the device D1 (210), without reacting with a rights issuer through network connection. The device D2 (220) then authenticates the second rights object to use content (step 5).

In the related art, since the device D2 (220) is an unauthorized device, it should receive a rights object from the rights issuer to use content. However, in this exemplary embodiment of the invention, the device D2 (220) receives a rights object from the device D1 (210) having the authorization signature information to use content.

In the configuration show in FIG. 2, when a specific user acquires a specific content and a rights object required to execute the content, the user representatively generates the rights object such that the rights object can also be used in another device. In this case, in order to prevent unauthorized proxy creation, only the second device receiving the authorization signature information from the service provider 100 can generate a second rights object, which makes it possible to improve convenience and to protect content.

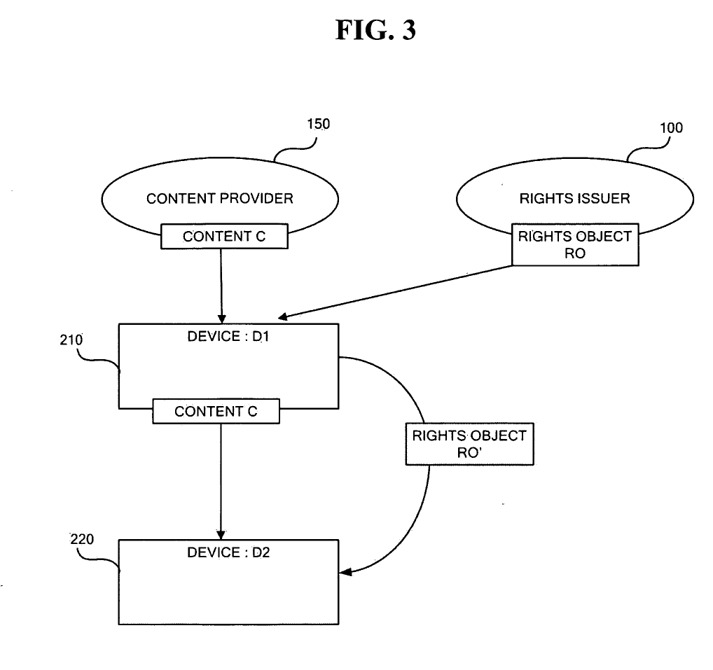

FIG. 3 is a diagram illustrating the creation of a rights object according to an exemplary embodiment of the invention. FIG. 3 shows a process in which the device D1 (210) having the corresponding rights object is delegated to generate the second rights object from the rights issuer 100 and transmits the second rights object. The device D1 (210) acquires content C from a content provider 150 and a rights object (RO) of the content from the rights issuer 100 and transmits the content C to another device that wants to use the content C, for example, the device D2 (220). Then, the device D1 (210) writes a signature on the rights object of the corresponding content with its own key again. In this case, it is assumed that the device D1 (210) is given the delegation of authority from the rights issuer 100. That is, the device D1 (210) regenerates a rights object RO′ with its own key by using its own authorization signature information and transmits the generated rights object to the device D2 (220).

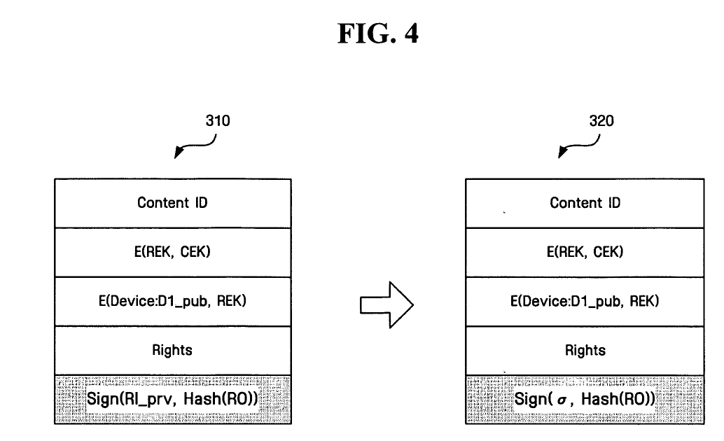

FIG. 4 is a diagram illustrating a change in the configuration of a rights object according to an exemplary embodiment of the invention. A rights object 310 issued from the rights issuer is signed with a private key of the rights issuer and is then transmitted to a device. The device (the device D1 (210) in FIG. 3) having received the rights object authenticates the rights object using its own public key of the rights issuer and then uses it. The rights object of the corresponding content transmitted from the device D1 (210) to the device D2 (220) is a second rights object 320. The device D1 (210) having the corresponding authorization signature information generates the rights object RO′ by using the authorization signature information and then transmits the generated rights object to the device D2 (220).

Meanwhile, an identifier of an unauthorized device receiving the second rights object may be added to the second rights object.

The term “module”, as used herein, means, but is not limited to, a software or hardware component, such as a Field Programmable Gate Array (FPGA) or Application Specific Integrated Circuit (ASIC), which performs certain tasks. A module may be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device.

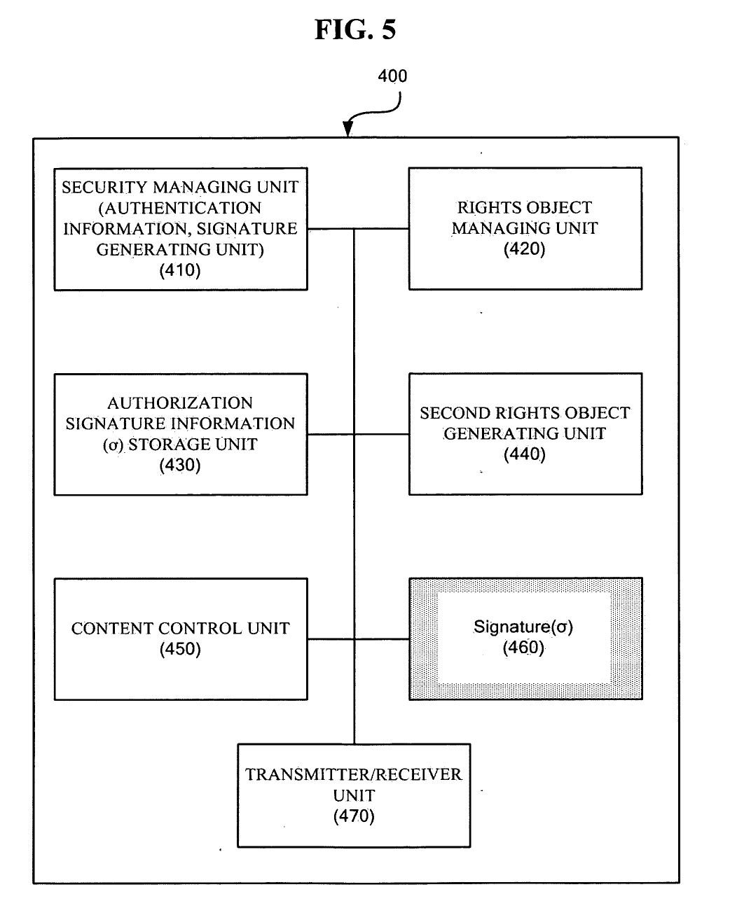

FIG. 5 is a diagram illustrating components of a device having authorization signature information according to an exemplary embodiment of the invention. A security manager or a security managing unit 410 generates a signature and information related to authentication. The security manager or the security managing unit 410 performs authentication with the rights issuer and performs an operation for receiving the authorization signature information from the rights issuer. A rights object managing unit 420 manages the rights object. The rights object is received from the rights issuer, and can be used by a second rights object generating unit 440 such that it can be used by another device. An authorization signature information storage or an authorization signature storage unit 430 stores an authorization signature received from the rights issuer, and the stored authorization signature can be used to generate a second rights object.

The second rights object generating unit 440 converts the rights object managed by the rights object managing unit 420 into a second rights object newly signed by using the authorization signature information such that another device can use the rights object.

A content control unit 450 transmits the content received from a content provider to a specific device. Of course, a rights object for the content is also generated by the second rights object generating unit 440 and is then transmitted to the specific device. A signature unit 460 performs a signing process so that the second rights object generating unit 440 can use the authorization signature information to encrypt the rights object.

A transmitter/receiver unit 470 exchanges information with the rights issuer or transmits the second rights object to an unauthorized device.

According to the above-mentioned configuration, the content purchased by a user can be freely transmitted in various periods of time within the range not departing from rights issuer's intentions and can be used.

When a device D1 (210) (for example 400 of FIG. 5) wants to be issued with a certain content C from the content provider and to use the issued content, the device D1 (210) is issued with a rights object for the content C from the rights issuer. The rights object managing unit 420 manages the issued rights object, and the device D1 (210) can utilize the rights object to use the content C under the control of the content control unit 450.

Meanwhile, when another device D2 (220) wants to use the rights object included in the device D1 (210) in order to use the content C, the device D1 (210) performs a process for allowing the device D2 (220) to use the rights object of the device D1 (210).

In order to execute this process, the device D1 (210) acquires the authorization signature information from the rights issuer. The authorization signature information includes information for allowing the device D1 (210) to execute a direct proxy signature for the content C. The device D1 (210) signs the rights object that is signed with a key of the rights issuer with its own private key to generate a second rights object RO′. The device D2 (220) having received the generated second rights object RO′ does not need to acquire the key of the rights issuer through the Internet, unlike the device D1 (210). Meanwhile, devices other than the device D2 (220) do not need to acquire the key required to use the transmitted rights object RO′ from the rights issuer, which makes it possible to reduce overheads due to the authentication process.

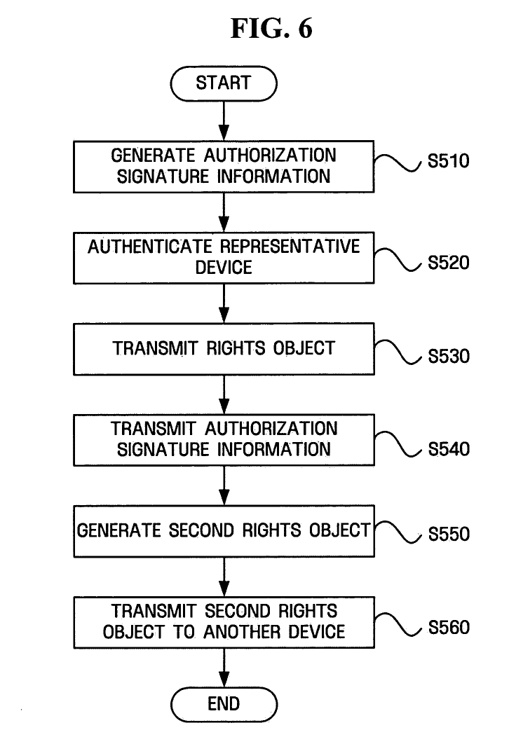

FIG. 6 is a flowchart illustrating a process of registering a device and generating a second rights object according to an exemplary embodiment of the invention.

First, the rights issuer creates authorization signature information (S510). The authorization signature information will be transmitted to a representative device later to generate the second rights object. The authorization signature information may be generated through a process of generating random numbers and calculating a signature key. After the authorization signature information is generated, the representative device is authenticated (S520). The representative device refers to a device capable of transmitting the second rights object to other devices. For example, the representative device may be authenticated by using identification information. When the authentication is completed, the rights issuer transmits the rights object to the representative device (S530). The transmitted rights object may be a rights object required to use the content held in the device, or it may be a rights object required to use the content directly transmitted from the representative device or the content provider.

When the representative device is authenticated, the rights object is transmitted (S530). The rights object is encrypted by using an encryption key created in the authentication process or a predetermined encryption key, and is then transmitted. Then, the authorization signature information is transmitted (S540). As described above, the authorization signature information includes an encryption key required to generate a new rights object or signature information. The representative device having received the rights object and the authorization signature information generates a second rights object (S550). The second rights object is generated by using key information σ included in the authorization signature information. At that time, usage rule information on an authorization signature key is also provided. Then, the generated second rights object is transmitted to another device (S560). Another device can utilize the second rights object to use the content.

An example of the configuration of the rights object to be transmitted from the rights issuer to the representative device in step S530 is as follows:

contentID ∥ E(REK, CEK) ∥ E(Device:D1_prv key, REK) ∥ Rights ∥ Sign(RI) ∥ Sign(RI, (RI ∥ K)).

In the example, contentID indicates a content identifier, REK indicates an encryption key of a rights object, and CEK indicates an encryption key of content. In addition, Device:D1_prv key indicates is a secret key of the device D1 (210), which is used to encrypt REK. Further, Rights indicates a rights object, and Sign(RI) and Sign(RI, (RI ∥ K)) indicate a signature and a verification value thereof, respectively.

An example of the process of transmitting the rights object with the authorization signature to another device in step S560 is as follows:

contentID ∥ E(REK, CEK) ∥ E(Device:D2_prv key, REK) ∥ Rights ∥ authorization signature ∥ authorization signature verification value (R, K) ∥ redistributor ID.

In the example, Device:D2_prv key indicates a secret key of the device D2 (220), and the device D2 (220) receives the rights object by means of an authorization signature. The authorization signature and the authorization signature verification value are obtained by the authorization signature information that is generated in step S520 and is then transmitted in step S540.

After step S560, the device D2 (220) having received the redistributed rights object RO′ determines whether the authorization signature is valid on the basis of the public key of the rights issuer. When the rights object acquired by the device D1 (210) is redistributed to the device D2 (220), the authorization signature information σ acquired in the registration stage and information on the authorization signature verification value included in the rights object RO′ are needed. Therefore, the device D1 (210) (or a device having the function of a local domain manager) can redistribute only information allowed by a server.

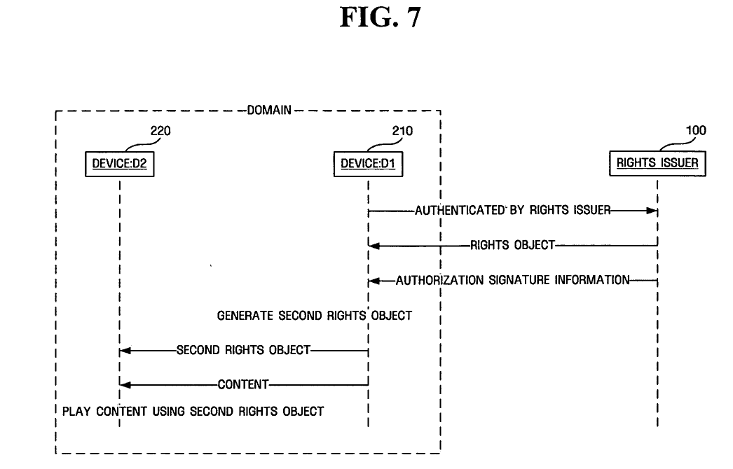

FIG. 7 is a diagram illustrating an example according to an exemplary embodiment of the invention. The rights issuer 100 authenticates the device D1 (210). When the authentication succeeds, the device D1 (210) receives a rights object from the rights issuer 100 and also receives authorization signature information. Then, the device D2 (220) belonging to the same domain as the device D1 (210) can use the rights object held in the device D1 (210) without the intervention of the rights issuer. At that time, in order to prevent unauthorized usage, the device D1 (210) generates a second rights object and then transmits the second rights object to the device D2 (220). The device D2 (220) may receive content from the device D1 (210) and use the second rights object. The device D1 (210) may transmit a portion of the content according to the second rights object. The content may be independently received from the content provider, or it may be received from the device D1 (210), serving as a representative device. The content may be received through various paths. Then, the device D2 (220) plays content using the second rights object.

As shown in FIG. 7, the device D2 (220) in the same domain can use the rights object without interaction with the rights issuer 100, and thus it is possible to shorten the time required to perform authentication with the rights issuer 100 or to receive the rights object. Meanwhile, whether the rights object is used in the same domain can be determined by the use of the same owner, which does not infringe on rights to use content.

While the exemplary embodiments of the invention have been described above with reference to the accompanying drawings, it will be understood by those skilled in the art that various modifications and changes of the invention can be made without departing from the scope and spirit of the invention. Therefore, it should be understood that the above-described exemplary embodiment is not restrictive, but illustrative in all aspects. The scope of the present invention is defined by the appended claims rather than by the description preceding them, and all changes and modifications that fall within meets and bounds of the claims, or equivalents of such meets and bounds are therefore intended to be embraced by the claims.

According to an aspect of the present invention, it is possible to regenerate a rights object RO for using content among various devices and transmit the rights object. That is, when rights to generate a rights object is delegated to regenerate the rights object, a device having the rights object can generate a suitable second rights object and transmit the second rights object to another device. Then, another device can also use the rights object.

Further, according to an aspect of the present invention, after accessing a rights issuer through a specific registration process, a corresponding device does not need to acquire a rights object of corresponding content from the rights issuer through additional Internet connection, and authentication information for a specific process of verifying a corresponding rights object RO′ is not needed, which makes it possible to easily use a rights object.

What is claimed is:

1. A method of transmitting authorization signature information, the method comprising:
authenticating a device;
transmitting to the device a first rights object required to use a certain content; and
transmitting to the device the authorization signature information required to convert the first rights object to a second rights object.

2. The method of claim 1, wherein the device is a representative device of a domain including the device.

3. A method of generating a rights object by a delegation of authority, the method comprising:
performing authentication with a rights issuer;
receiving a first rights object from the rights issuer;
receiving authorization signature information from the rights issuer;
converting the first rights object into a second rights object by using the authorization signature information; and
transmitting the second rights object to an unauthorized device.

4. The method of claim 3, further comprising transmitting to the unauthorized device content capable of being used by the first rights object.

5. The method of claim 3, wherein the unauthorized device is included in the same domain as the device authenticated by the rights issuer.

6. The method of claim 3, wherein the authorization signature information comprises an encryption key required to decrypt the second rights object.

7. The method of claim 3, wherein the authorization signature information comprises an identifier of the unauthorized device.

8. The method of claim 3, wherein the second rights object is used in only the unauthorized device.

9. An apparatus for generating a rights object by a delegation of authority, the apparatus comprising:
a security managing unit which performs authentication with a rights issuer and manages a first rights object from the rights issuer;
an authorization signature information storage unit which receives authorization signature information from the rights issuer and stores the received authorization signature information;
a second-rights-object generating unit which converts the first rights object into a second rights object by using the authorization signature information; and
a transmitter/receiver unit which transmits the second rights object to an unauthorized device.

10. The apparatus of claim 9, wherein the transmitter/receiver unit receives the first rights object or the authorization signature information from the rights issuer.

11. The apparatus of claim 9, wherein the transmitter/receiver unit transmits to the unauthorized device content capable of being used by the first rights object.

12. The apparatus of claim 9, wherein the unauthorized device is included in the same domain as the device authenticated by the rights issuer.

13. The apparatus of claim 9, wherein the authorization signature information comprises an encryption key required to decrypt the second rights object.

14. The apparatus of claim 9, wherein the authorization signature information comprises an identifier of the unauthorized device.

15. The apparatus of claim 9, wherein the second rights object is used in only the unauthorized device.
